(19) United States
(12) Patent Application Publication
(10) Pub. No.: US 2008/0242234 A1
(43) Pub. Date: Oct. 2, 2008

(54) Minimizing the noise figure of broadband frequency agile radio receivers

(76) Inventors: Nicholas P. Cowley, Wroughton (GB); Richard J. Goldman, Oakengales (GB)

Correspondence Address: INTEL CORPORATION;c/o INTELLEVATE, LLC, P.O. BOX 52050, MINNEAPOLIS, MN, 55402, US

(21) Appl. No.: 11/731,160

(22) Filed: Mar. 30, 2007

(51) Int. Cl. H04B 1/38

(52) U.S. Cl. 455/73

(57) ABSTRACT

A wireless device includes an impedance transforming network that couples an antenna to a Low Noise Amplifier (LNA) and includes at least one digitally controllable variable capacitor that may be adjusted to maximize an impedance transformation ratio on a desired channel. A tuned response centered on the desired channel provides attenuation to undesired channels.

Technological developments permit digitization and compression of large amounts of voice, video, imaging, and data information. Evolving applications have greatly increased the transfer of large amounts of data from one device to another or across a network to another system. The Radio Frequency (RF) platforms used in transferring data across networks include a Low Noise Amplifier (LNA) responsible for providing reasonable power gain and linearity in amplifying the received signal, while not degrading the signal-to-noise ratio. The LNA is of major importance in the RF receiver block and improvements are needed.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device that implements an impedance transforming network located between the antenna and the low noise amplifier of the receiver in accordance with the present invention;

FIG. 2 is a simplified illustration of the impedance transforming network;

FIG. 3 illustrates simulation results for the RF LNA and the impedance transforming network at 450 MHz; and

FIG. 4 illustrates simulation results for the RF LNA and the impedance transforming network at 900 MHz.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

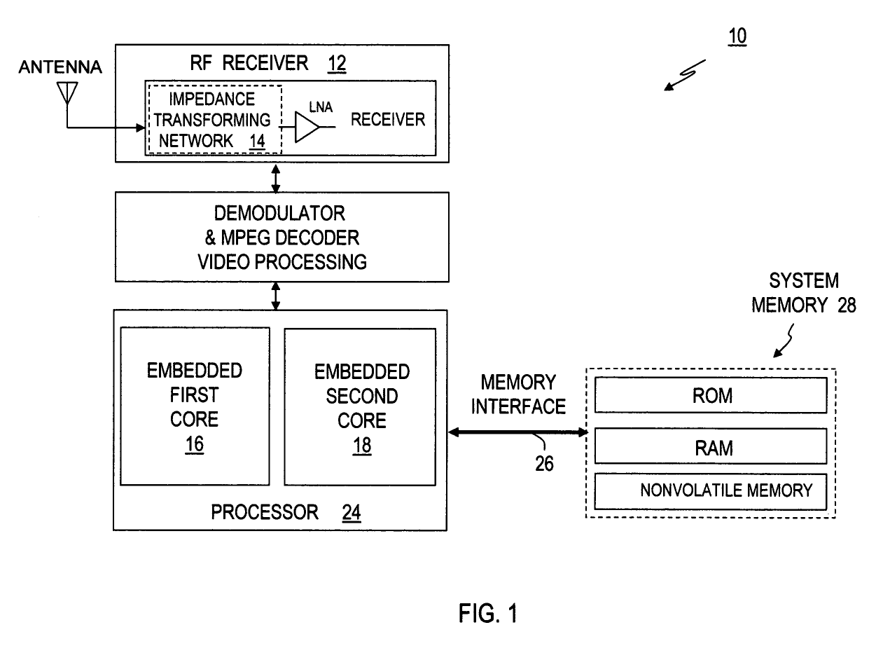

The embodiment illustrated in FIG. 1 shows a wireless communications device 10 that may include one or more radios to allow communication with other over-the-air communication devices. The embodiment illustrates the coupling of antenna(s) to a receiver 12 to accommodate demodulation of digital television transmissions. The present invention may be used in a variety of products, with the claimed subject matter incorporated into set top boxes, desktop computers, laptops, smart phones, MP3 players, cameras, communicators and Personal Digital Assistants (PDAs), medical or biotech equipment, automotive safety and protective equipment, automotive infotainment products, etc. However, it should be understood that the scope of the present invention is not limited to these examples, nor is it limited to receivers for digital terrestrial television, noting that the present invention could be deployed in applications such as WiFi, WiMax, etc.

In general, the illustrated wireless embodiment shows an analog front end receiver 12 that may be a stand-alone Radio Frequency (RF) discrete device or embedded with a part or all of the demodulator decoder function as a mixed-mode integrated circuit. The front end incorporates functions that are interfaced with a processor 24. Processor 24 may include baseband and applications processing functions and utilize one or more processor cores 16 and 18 to handle application functions and allow processing workloads to be shared across the cores. The processor may transfer data through an interface 26 to memory storage in a system memory 28.

FIG. 1 further illustrates an impedance transforming network 14 located between the antenna(s) and the Low Noise Amplifier (LNA) of the receiver. The impedance transforming network 14 improves the sensitivity of the LNA in the receiver for broadband reception by introducing a tunable impedance conversion network. The resonant frequency of impedance transforming network 14 may be adjustable for the bandwidth frequency of the selected channel.

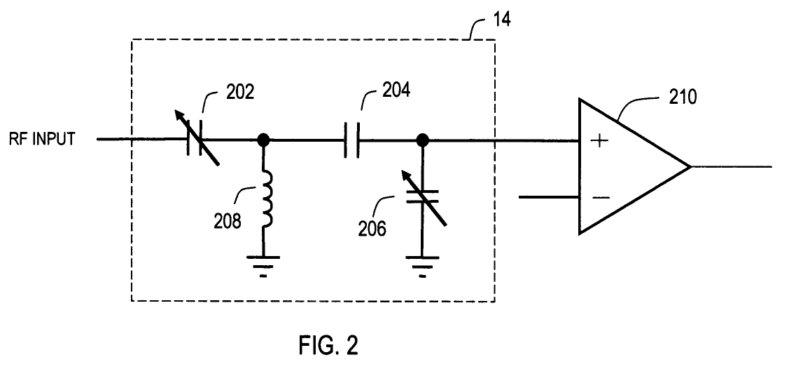

FIG. 2 shows a simplified embodiment of impedance transforming network 14 that may be formed in accordance with the present invention using capacitors 202, 204, 206, and an inductor 208. In the various embodiments for impedance transforming network 14, some combination of the capacitors and the inductor may be discrete components that are fabricated separate from the receiver, or the capacitors and the inductor may be fabricated on-chip and integrated with the receiver. Capacitor 206 is shown in the figure as a digitally controllable variable capacitor and capacitor 202 may be a fixed capacitor, or alternatively, a digitally controllable variable capacitor.

The present invention uses the impedance transforming network 14 to couple the antenna to the LNA. Series connected capacitors 202 and 204 are coupled between an RF input that receives an antenna signal and an output. A common connection of capacitors 202 and 204 is coupled to ground through inductor 208 and the output of the impedance transforming network is coupled to ground through capacitor 206. A non-critical amplifier 210 may be coupled to the output of the impedance transforming network 14.

Whereas traditional LNAs include degenerative feedback that necessitates a high power to deliver the required combination of signal handling and Noise Factor (NF), the present invention incorporates a passive network to improve the operating dynamic range of the LNA while reducing power dissipation. Achieving the desired performance with a minimum power dissipation is desirable for applications in battery powered, mobile platforms.

In addition, the relatively low impedance of the antenna that is typically measured in the 10s of ohms range needs to be appropriately impedance matched to the LNA. The capacitance value of capacitor 208 may be adjusted such that the impedance transformation ratio of impedance transforming network 14 is maximized on the desired channel. In addition, a tuned response centered on the desired channel provides attenuation to undesired channels, further reducing contamination introduced from these channels. Further, using a digitally programmable on-chip variable capacitor (capacitors 202 and 206, for example) within impedance transforming network 14 allows a calibration of any initial tuning errors in the transformation network. By using a calibration tone and a maximal amplitude detect algorithm, a predictive correction factor may be utilized.

Impedance transforming network 14 provides a voltage transformation step up from the antenna to the LNA input. By way of example, impedance transforming network 14 may provide an input impedance of 50 ohm and an output impedance of 500 ohm. The following equations derive a voltage step up ratio of about 3.2 for this example as follows:

$$Pin = Pout$$

$$\frac{{( Vin )}^{2}}{Rin} = \frac{{( Vout )}^{2}}{Rout}$$

$$\frac{{( Vout )}^{2}}{{( Vin )}^{2}} = \frac{Rout}{Rin} \\ Voltage step up ratio = \frac{( Vout )}{( Vin )} = \sqrt{( \frac{Rout}{Rin} )} = \sqrt{( \frac{500}{50} )} \approx 3.2$$

The impedance transformation ratio ‘steps up’ the incident noise voltage and signal to mitigate the effect of LNA additive noise. Without impedance transforming network 14, a standing wave ratio from a mismatched antenna may cause reflections of power back into the transmitter, which may cause heating in the transmitter and significant power loss.

By combining impedance transforming network 14 with the LNA, the source noise voltage is increased by a factor of 3.2 and the additive noise voltage contribution from the LNA is reduced, producing a lower NF. Conversely, the same NF as a traditional front end may be produced with an increased (3.2× greater) additive noise voltage—corresponding to reduced power, greater degenerative feedback or some combination of both. One potential drawback with this approach is that the input terminal voltage to the LNA has increased, causing the required signal handling to increase. However, in accordance with the present invention the degenerative feedback may now be increased for the same additive noise degradation, which increases the signal handling.

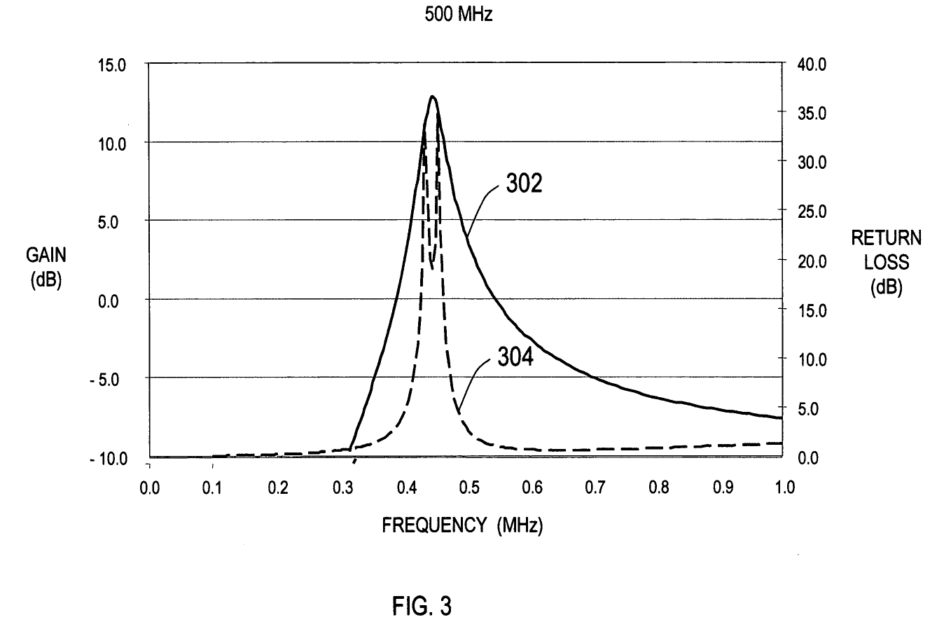

FIG. 3 illustrates simulation results for voltage transformation and return loss for the RF LNA and the impedance transforming network 14 transforming from 50 ohm to 1 Kohm at 500 MHz. The gain is denoted in the figure by the reference number 302. The return loss is denoted in the figure by the reference number 304, where return loss is a summation of all the reflected signal energy coming backward toward the end where it originated. Return loss varies with frequency for resistive loads and can be affected by discontinuities and impedance mismatches.

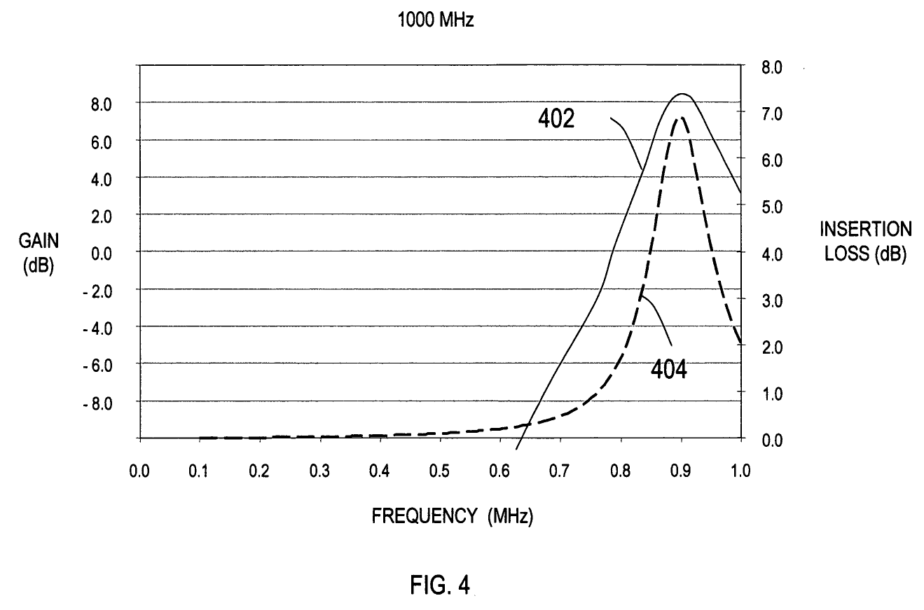

FIG. 4 illustrates simulation results for voltage transformation and return loss for the RF LNA and the impedance transforming network 14 transforming from 50 ohm to 1 Kohm at 1000 MHz. The gain is denoted in the figure by the reference number 402, while the insertion loss is denoted in the figure by the reference number 404. Insertion loss is the decrease in transmitted signal power resulting from the transmission line, usually expressed in decibels (dB). Line terminations reflect some of the power and play an important part in insertion loss.

Due to the limited antenna gain and requirements for selectivity filtering to attenuate co-existence signals, the desired channel signal strength received by wireless communications device 10 may be very low. In accordance with the present invention, impedance transforming network 14 provides a reactive transformation that may be tuned to the desired channel and provide a maximum voltage step up on the desired channel. The present invention also provides a decreasing (channel offset) step up ratio to undesired interfering signals, further providing a selectivity protection benefit to the undesired interfering signals.

By now it should be apparent that embodiments of the present invention provide tunable selectivity protection to help mitigate against co-existence blocking signals and undesired channel interference. By using the impedance transforming network, greater receiver sensitivity may be realized in Digital Video Broadcasting-Handheld (DVB-H) and Terrestrial-Digital Multimedia Broadcasting (T-DMB). DVB-H is a technical specification for bringing broadcast services to handheld receivers. T-DMB Digital Multimedia Broadcasting (DMB) is a digital radio transmission system for sending multimedia (radio, TV and data casting) on terrestrial and satellite radio frequency bands to mobile devices. Thus, wireless communications devices using the embodiments of the present invention may improve performance in coexistence environments at a lower power and application solution cost.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless device, comprising:
an antenna;
an impedance transforming network that includes series connected first and second capacitors coupled between an input that receives an antenna signal and an output, where a common connection of the first and second capacitors is coupled to a ground conductor through an inductor and the output of the impedance transforming network is coupled to the ground conductor through a third capacitor; and
a Low Noise Amplifier (LNA) having an input coupled to the output of the impedance transforming network.

2. The wireless device of claim 1, wherein the third capacitor is a digitally controllable variable capacitor.

3. The wireless device of claim 1, wherein the first capacitor is a digitally controllable variable capacitor.

4. The wireless device of claim 1 wherein the impedance transforming network provides a reactive transformation that is tuned to a desired channel to provide a maximum voltage step up on the desired channel.

5. The wireless device of claim 4 wherein a capacitance value of the third capacitor is adjusted to maximize an impedance transformation ratio on the desired channel.

6. The wireless device of claim 5 wherein digitally programming the third capacitor allows a calibration of initial tuning errors in the impedance transforming network.

7. A radio having an antenna, comprising:
a Low Noise Amplifier (LNA) to receive an RF signal; and
an impedance transforming network to couple the antenna to the LNA and including first and second serially connected capacitors with a common connection coupled through an inductor to a ground conductor, where a terminal of the second capacitor is coupled through a third capacitor to the ground conductor and further connects to the LNA.

8. The radio of claim 7, wherein the first capacitor is a variable capacitor.

9. The radio of claim 7, wherein the third capacitor is a variable capacitor.

10. The radio of claim 7 wherein adjusting a capacitance of the third capacitor changes an impedance transformation ratio.

11. The radio of claim 10 wherein the impedance transformation ratio is maximized on a desired channel.

12. The radio of claim 10 wherein a tuned response centered on the desired channel provides attenuation to undesired channels.

13. A wireless device to demodulate an RF signal, comprising:
an antenna to receive the RF signal;
a Low Noise Amplifier (LNA) to provide gain to the received RF signal; and
an impedance transforming network that couples the antenna to an input of the LNA to improve a sensitivity of the LNA for broadband reception through a tunable impedance conversion network formed on-chip by first and second serially connected capacitors and a third variable capacitor coupled from the input of the LNA to a ground conductor.

14. The wireless device of claim 13, further including an inductor coupled from a common connection of the first and second serially connected capacitors to the ground conductor.

15. The wireless device of claim 13, wherein the first capacitor of the first and second serially connected capacitors is a variable capacitor.

16. The wireless device of claim 13, wherein the third capacitor is variable to tune a resonant frequency of the impedance transforming network for a bandwidth of a selected channel.

17. A device to demodulate digital television transmissions, comprising:
an antenna to receive a signal;
a Low Noise Amplifier (LNA) coupled to the antenna; and
an impedance transforming network coupled between the antenna and the LNA to digitally tune an impedance to enhance a Noise Factor (Nf).

18. The device of claim 17 wherein the device is a Digital Video Broadcasting-Terrestrial (DVB-T) receiver.

19. The device of claim 17 wherein the impedance transforming network provides a tuned response centered on a desired channel to provide attenuation to undesired channels.

20. The device of claim 17 wherein the impedance transforming network includes:
first and second serially connected capacitors coupled from the antenna to an input of the LNA and a variable capacitor coupled from the input of the LNA to a ground conductor; and
an inductor coupled from a common connection of the first and second serially connected capacitors to the ground conductor.

21. The device of claim 20 wherein the first serially connected capacitor is integrated on-chip with the LNA.

22. The device of claim 20 wherein the second serially connected capacitor is integrated on-chip with the LNA.

23. The device of claim 20 wherein the variable capacitor is integrated on-chip with the LNA.

24. The device of claim 20 wherein the inductor is on-chip with the LNA.
